(19) United States
(12) Patent Application Publication
(10) Pub. No.: US 2023/0385899 A1
(43) Pub. Date: Nov. 30, 2023

(54) Vehicle Recommendation Method and Server for Providing Vehicle Recommendation Service

(71) Applicants: Hyundai Motor Company, Seoul (KR); Kia Corporation, Seoul (KR)

(72) Inventors: Jeewook Huh, Seoul (KR); Dong Ho Yang, Incheon (KR); Hong Suk Kwak, Seoul (KR); Dong-Su Ha, Hwaseong-si (KR)

(21) Appl. No.: 17/977,491

(22) Filed: Oct. 31, 2022

(30) Foreign Application Priority Data
May 27, 2022 (KR) 10-2022-0065353

(51) Int. Cl. G06Q 30/06; G06Q 30/02

(52) U.S. Cl. CPC G06Q 30/0631; G06Q 30/0203; G07C 5/10

(57) ABSTRACT

An embodiment method includes providing a question for a user and a user propensity test, receiving responses to the question for the user and the user propensity test and determining a user propensity based on the responses, and calculating vehicle propensities for indicating vehicle characteristics on vehicles. Calculating the vehicle propensities includes extracting a platform applying time of each of the vehicles and a used fuel type from vehicle data and determining a weight on one of a plurality of vehicle propensity elements by summing platform scores according to the platform applying time and energy source scores according to the used fuel type. The method further includes determining target vehicles belonging to a budget range from among the vehicles and determining an optimal vehicle from among the target vehicles based on matching degrees of the user propensity and the respective target vehicles.

### CROSS-REFERENCE TO RELATED APPLICATIONS

This application claims the benefit of Korean Patent Application No. 10-2022-0065353, filed on May 27, 2022, which application is hereby incorporated herein by reference.

### TECHNICAL FIELD

The present invention relates to a vehicle recommending method and a server for providing a vehicle recommending service.

### BACKGROUND

As personalities of individuals become important, propensity tests on the persons are performed in various forms. When results of the propensity tests on the persons are used, propensities of other parties may be known so social consensus may be increased.

When a person determines a career path or when a company assigns tasks to individuals, while quantitative indexes such as credit or test scores were mainly considered in the past, the personal propensities have been recently used to forecast career paths that are suitable to them, or business competitive power is reinforced according to a task progress that fits the propensities, so methods for considering the personal propensities are currently researched in the various industrial fields.

The above information disclosed in this background section is only for enhancement of understanding of the background of embodiments of the invention, and therefore it may contain information that does not form the prior art that is already known to a person of ordinary skill in the art.

### SUMMARY

Embodiments of the present invention provide a method and a server for, when providing a service for recommending a vehicle to be purchased by a client, connecting propensities of the client to technical elements of the vehicle considering a year-based model of a frame or a used fuel applied to the vehicle, recommending a vehicle to which an option specification that is appropriate for a type of road on which the client travels, and accordingly transmitting optimal vehicle information.

An embodiment of the present invention provides a vehicle recommending method performed by a service providing server including providing a question for a user and a user propensity test to an application through a user terminal, receiving responses to the question for a user and the user propensity test from the user terminal and determining a user propensity based on the responses, calculating a plurality of vehicle propensities for indicating vehicle characteristics on a plurality of vehicles, determining a plurality of target vehicles belonging to a vehicle purchase budget range of the user from among the vehicles, and determining at least one optimal vehicle from among the target vehicles based on matching degrees of the user propensity and the respective target vehicles, wherein the calculating of the plurality of vehicle propensities includes extracting a platform applying time of a vehicle and a used fuel type from vehicle data, and determining a weight on one of a plurality of vehicle propensity elements on the vehicle by summing platform scores according to the platform applying time and the energy source scores according to the used fuel type.

The determining of a weight on one of a plurality of vehicle propensity elements may include computing platform score differences for respective years by dividing a difference between a highest score of the platform score and a lowest score of the platform score by a difference between a current year and a year to which the first platform among platforms applied to commercial vehicles is applied, and determining the platform score by multiplying a number of years from the platform applying time of the vehicle to the current year with the platform score difference for respective years.

The determining of a weight on one of a plurality of vehicle propensity elements may include determining the energy source score by summing the score according to a used fuel type of the vehicle and the score according to a type of a fuel system of the vehicle.

The determining of a user propensity may include, when receiving a response to a high-speed driving ratio of the user from the user terminal, determining the high-speed driving ratio of the user according to the response.

The vehicle recommending method may further include, when not receiving the response, determining a high-speed driving ratio of the user by dividing a subtraction of a reference value of a city driving per unit duration of the user from a driving distance of the vehicle per the unit duration by a difference between the high-speed driving reference value per unit duration and the reference value of city driving.

The calculating of a plurality of vehicle propensities may further include determining a driving technology score by summing scores of respective driving option specifications on a function for supporting a driver while driving a vehicle from among a plurality of option specifications applied to the vehicle, determining a stopping technology score by summing scores of respective stopping option specifications on stopping or parking from among the option specifications, determining a technology option score by adding a product of the driving technology score and the high-speed driving ratio and a product of the stopping technology score and a low-speed driving ratio according to the high-speed driving ratio, and determining the weight on the one element on the vehicle based on the platform score, the energy source score, and the technology option score.

Another embodiment of the present invention provides a service providing server including a processor connected to a memory for storing program codes including a collecting unit for collecting user information that is a response to a question for a user and a response to a user propensity test from a user terminal, a user propensity determining unit for determining the user propensity based on the user information and the response to a user propensity test, a vehicle propensity calculating unit for calculating a plurality of vehicle propensities indicating characteristics of a plurality of vehicles, extracting a platform applying time of the vehicle and a type of a used fuel from vehicle data, and summing a platform score according to the platform applying time and an energy source score according to the type of the used fuel to determine a weight on one of a plurality of vehicle propensity elements indicating the vehicle propensity, and an optimal vehicle determining unit for determining a plurality of target vehicles belonging to a vehicle purchase budget range of the user from among the vehicles, and determining an optimal vehicle from among the target vehicles according to a matching degree by which the respective target vehicles match the user propensity.

The vehicle propensity calculating unit may compute platform score differences for respective years by dividing a difference between a highest score of the platform score and a lowest score of the platform score by a difference between a current year and a year to which the first platform among platforms applied to commercial vehicles is applied, and may determine a platform score of the vehicle by multiplying a number of years from the platform applying time of the vehicle to the current year with the platform score difference for respective years.

The vehicle propensity calculating unit may determine the energy source score by a summation of a score according to a type of a used fuel of the vehicle and a score according to a type of a fuel system of the vehicle.

The user propensity determining unit may inquire the user terminal for a high-speed driving ratio of the user, may determine a high-speed driving ratio of the user according to the response when receiving a response to the inquiry, and may determine, when not receiving the response, the high-speed driving ratio of the user by dividing a subtraction of a reference value of city driving per unit duration of the user from a driving distance of the vehicle per the unit duration by a difference between the high-speed driving reference value per unit duration and the reference value of city driving.

The vehicle propensity calculating unit may determine a technology option score by adding a product of a driving technology score that is a summation of scores of respective driving option specifications on a function for supporting a driver while driving the vehicle from among a plurality of option specifications applied to the vehicle and the high-speed driving ratio and a product of a stopping technology score that is a summation of scores of respective stopping option specifications on stopping or parking from among the option specifications and a low-speed driving ratio according to the high-speed driving ratio, and may determine the weight on the one element on the vehicle based on the platform score, the energy source score, and the technology option score.

According to embodiments of the present invention, the propensity test is provided to the user, the user propensity is determined based on the propensity test result, the propensity elements of the vehicle are calculated by considering the year-based model of the frame such as the platform applied to the vehicle or the type of the used fuel, or the propensity elements of the vehicle are calculated by considering whether the user generally drives on a highway or a downtown road and the option specification applied to the vehicle to provide information on the optimized vehicle that is appropriate for the user to buy and increase satisfaction of the user who is served with the service.

### BRIEF DESCRIPTION OF THE DRAWINGS

FIG. 1 shows a schematic block diagram on a vehicle recommending system for providing a vehicle purchase information service according to an embodiment.

FIG. 2 shows a flowchart on a vehicle recommending method according to an embodiment.

FIG. 3 shows a detailed flowchart of S4 of FIG. 2.

FIG. 4 shows a detailed flowchart of S4 of FIG. 2.

The following reference identifiers may be used in connection with the accompanying drawings to describe exemplary embodiments of the present disclosure.
1: vehicle recommending system
11: service providing server
111: collecting unit
112: user propensity determining unit
113: vehicle propensity calculating unit
114: optimal vehicle determining unit
12: user terminal
121: application

### DETAILED DESCRIPTION OF ILLUSTRATIVE EMBODIMENTS

Embodiments disclosed in the present specification will be described in detail with reference to the accompanying drawings. In the present specification, the same or similar components will be denoted by the same or similar reference numerals, and an overlapped description thereof will be omitted. The terms “module” and “unit” for components used in the following description are used only in order to make the specification clearer. Therefore, these terms do not have meanings or roles that distinguish them from each other by themselves. In describing embodiments of the present specification, when it is determined that a detailed description of the well-known art associated with embodiments of the present invention may obscure the gist of the embodiments of the present invention, it will be omitted. The accompanying drawings are provided only in order to allow embodiments disclosed in the present specification to be easily understood and are not to be interpreted as limiting the spirit disclosed in the present specification, and it is to be understood that the present invention includes all modifications, equivalents, and substitutions without departing from the scope and spirit of the present invention.

Terms including ordinal numbers such as first, second, and the like will be used only to describe various components, and are not interpreted as limiting these components. The terms are only used to differentiate one component from others.

It is to be understood that when one component is referred to as being “connected” or “coupled” to another component, it may be connected or coupled directly to another component or be connected or coupled to another component with yet another component intervening therebetween. On the other hand, it is to be understood that when one component is referred to as being “connected or coupled directly” to another component, it may be connected or coupled to another component without yet another component intervening therebetween.

It will be further understood that terms “comprises” or “have” used in the present specification specify the presence of stated features, numerals, steps, operations, components, parts, or a combination thereof, but do not preclude the presence or addition of one or more other features, numerals, steps, operations, components, parts, or a combination thereof.

In addition, the terms “-er”, “-or”, and “module” described in the specification mean units for processing at least one function and operation, and can be implemented by hardware components or software components, and combinations thereof.

A user propensity may include personal propensities that may be considered when a vehicle is purchased from among various personal propensities. The respective personal propensities will be referred to as user propensity elements. A vehicle propensity may include qualitative characteristics of the vehicle that corresponds to the user propensity. The user refers to the client who desires to receive a vehicle recommendation by using vehicle purchase information service according to an embodiment.

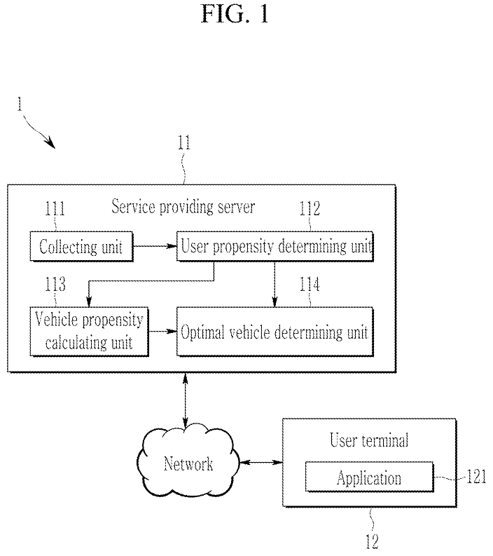

FIG. 1 shows a schematic block diagram on a vehicle recommending system for providing a vehicle purchase information service according to an embodiment.

A vehicle purchase information service may include a service for providing information on vehicles purchasable by the user to a user terminal through an application.

The vehicle recommending system 1 may include a service providing server 11 and a user terminal 12, which are connected to each other in a network. An application 121 is installed in the user terminal 12. As is already known, the service providing server 11 may be realized with a processor for executing program codes or instructions stored in a memory.

The service providing server 11 may provide a vehicle purchase information service to the user according to a response to user information and a user propensity test provided by the user terminal 12. The user information is used for the service providing server 11 to provide a vehicle purchase information service, and may be used to reduce a number of categories of the vehicles. For example, the user information may include a vehicle purchase budget of the user, a number of passengers to get in the vehicle, an age of the user, a use of the vehicle, a driving distance of the vehicle per duration, and a selling time of a used vehicle. A question for obtaining the user information will be referred to as a question for the user.

The user propensity test may include questions needed for the service providing server 11 to determine a propensity (hereinafter, user propensity) for the user to purchase a vehicle. The application 121 may receive a user propensity test from the service providing server 11 through the user terminal 12. When the user responds to the user propensity test, the application 121 may transmit the response of the user to the service providing server 11 through the user terminal 12.

A signal received to the user terminal 12 from the service providing server 11 may be processed as information by an application processor (AP) of the user terminal 12, and the AP may transmit the information to the application 121. The application 121 may perform a calculation based on information received from the AP, and may display a calculated result to the user terminal 12 or may transmit the same to the service providing server 11 through the user terminal 12. For example, the application according to an embodiment may perform a determination according to the information received from the service providing server 11 through the user terminal 12, may display a determined result to the user terminal 12, may process information based on an input provided by the user terminal 12, and may transmit the processed information to the service providing server 11 through the user terminal 12.

The service providing server 11 may include a collecting unit 11, a user propensity determining unit 112, a vehicle propensity calculating unit 113, and an optimal vehicle determining unit 114.

The collecting unit 11 transmits a user propensity test including questions for the user and questions for determining the user propensity to the user terminal 12, and collects user information and a user propensity test response (hereinafter, user propensity response) received from the user terminal 12. The collecting unit 11 may store the collected user information and the user propensity response in a database.

The user propensity determining unit 112 may determine the user propensity based on the user propensity response collected by the collecting unit 111. The user propensity determining unit 112 may determine a high-speed driving ratio and/or a low-speed driving ratio of the user. The high-speed driving ratio represents a ratio for the user to drive the vehicle on a highway or a driveway, and the higher the high-speed driving ratio is, the lower the stopping or parking ratio while driving is. The low-speed driving ratio represents a ratio for the user to drive the vehicle on a downtown road or an alley, and the higher the low-speed driving ratio is, the higher the stopping or parking ratio while driving is. The high-speed driving ratio and the low-speed driving ratio may be complementary numerical values. For example, when the high-speed driving ratio is 60%, the low-speed driving ratio may be 40%.

The vehicle propensity calculating unit 113 may calculate a propensity of the vehicle (hereinafter, vehicle propensity) based on a plurality of vehicle data. The vehicle data may include exterior and performance of the vehicle such as data, prices, colors, and specifications of the vehicle. The vehicle data may be stored in a database or may be collected from a server managed by a vehicle maker. When there are a plurality of powertrain types applied to the vehicle, the respective powertrains are distinguished into individual vehicles. For example, an Avante with a 1.6 liter gasoline engine and an Avante N-line may be distinguished to be different vehicles.

The vehicle propensity calculating unit 113 may determine platform scores and energy source scores according to platforms and energy sources of a plurality of vehicles, may compute technology scores of the respective vehicles based on the platform scores and the energy source scores, and may determine weights on technical values according to the technology scores. The platform may represent a core structure, such as a vehicle frame, that is commonly applied irrespective of vehicle models. The platform may include an engine compartment and an underbody (bottom portion of the vehicle body) layout. The platforms have common characteristics for respective year-based models. The vehicle propensity calculating unit 113 may determine the technology option score by considering the high-speed driving ratio and/or the low-speed driving ratio of the user and the option specification applied to the vehicle, and may determine the weight on the technical values of the vehicle based on the technology scores and the technology option scores. The option specification excludes a specification that is a reference for selecting a vehicle type from among a plurality of option specifications of the vehicle. The specification that is a reference for selecting a vehicle type may include the powertrain. The option specifications may include specifications on driving safety, specifications on exteriors and interiors of the vehicles, convenience specifications on vehicle sheets and improvements of driving conveniences, and uses relating to infotainment.

The optimal vehicle determining unit 114 may determine vehicles (hereinafter, a plurality of target vehicles) within a vehicle purchase budget range of the user from among a plurality of vehicles based on user information, user propensities, and vehicle propensities on a plurality of vehicles, and may arrange the target vehicles in order from the greatest degree to the smallest one that match the user propensities (hereinafter, matching degrees). The optimal vehicle determining unit 114 may assign an order to the respective target vehicles in order from the greatest matching degree to the smallest one (hereinafter, matching order). The optimal vehicle determining unit 114 may determine at least one vehicle (hereinafter, optimal vehicle) to be proposed to the user terminal 12 from among a plurality of target vehicles. The optimal vehicle represents a predetermined number of vehicles of which the matching order is a prior order from among a plurality of target vehicles. The optimal vehicle determining unit 114 may propose data on the determined optimal vehicle to the user terminal 12.

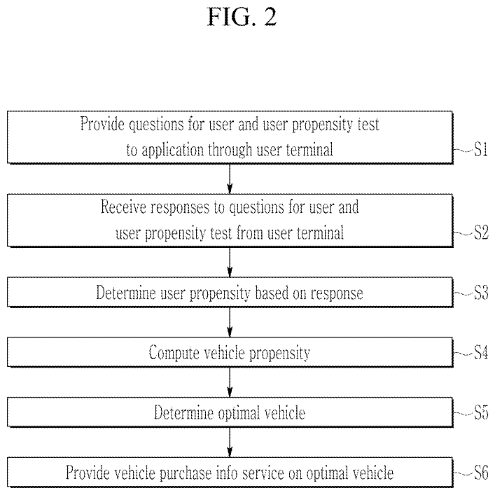

Operations of respective components of the vehicle recommending system 1 will now be described with reference to FIG. 2 to FIG. 4.

FIG. 2 shows a flowchart on a vehicle recommending method according to an embodiment.

The collecting unit 111 may provide the questions for the user and the user propensity tests to the application 121 through the user terminal 12 (S1). When receiving the questions for the user and the user propensity tests, the application 121 may receive responses to the questions for the user and the user propensity tests from the user through the user terminal 12. For example, the user who desires to buy a vehicle may input the response to the questions for the user and the user propensity tests to the user terminal 12.

The collecting unit 111 may receive the responses to the questions for the user and the user propensity tests from the user terminal 12 (S2). The collecting unit 111 may transmit the received responses to the user propensity determining unit 112.

The user propensity determining unit 112 may determine a user propensity based on the responses to the questions for the user and the user propensity tests (S3). The user propensity determining unit 112 may analyze the responses to the questions for the user and the user propensity tests and may determine the user propensity. The questions for the user may include questions on a vehicle purchase budget of the user, a number of passengers who will get in the vehicle, an age of the user, a use of the vehicle, and a driving distance of the vehicle per unit duration. The user propensity test may include questions for the service providing server 11 to determine the user propensity. For example, the user propensity test may include questions such as “Which destination do you prefer, vacation spots or tourist attractions?”

The user propensity may be determined by a plurality of user propensity elements. The user propensity elements may include economic feasibility indicating a degree of concern of the user on the vehicle price, safety indicating a degree of concern of the user on a defense function of the vehicle against accidents, self-consciousness indicating a degree of concern of the user on an estimation on another user, technical values indicating a degree of concern of the user on new technologies applied to the vehicle, reliability indicating a degree of concern of the user on quality estimation on the vehicle, functionality indicating a degree of concern of the user on performance of the vehicle, and an aesthetic impression indicating a degree of concern of the user on a design of the vehicle. It may be determined that the higher the self-consciousness is, the greater the desire is for the user to show off his vehicle. However, the user propensities are not limited to the above-noted content. That is, various elements that may be considered in determining the user propensities may be further considered in determining the user propensities. The user propensity test may not be a question for directly asking the user propensity, but may be a question on a value determination of the user relating to the user propensity.

The user propensity determining unit 112 may calculate weights on the user propensity elements based on the response to the user propensity test, and may determine the user propensity based on the calculated weights. The user propensity determining unit 112 may perform a clustering operation for classifying users into a predetermined number of groups (hereinafter, user propensity group) indicating user propensities when determining the user propensities. The user propensity determining unit 112 may set a plurality of user propensity groups based on importance distributions for respective user propensity elements, may match the importance distributions for the respective user propensity elements based on the response to the user propensity tests for the respective users and similar groups from among a plurality of user propensity groups, and may determine the user propensity to thus perform the clustering operation.

To determine the user propensity groups, the user propensity determining unit 112 may store the responses to the user propensity tests, and may apply a clustering operation to the stored data when the stored data is equal to or greater than a predetermined size. A number N (N is a natural number) of the user propensity groups may be determined according to the clustering result, and the user propensity determining unit 112 may define respective characteristics of N-numbered groups according to the importance distributions of the user propensity elements of the respective groups. When the user propensity determining unit 112 fails to store a sufficient amount of response data to the user propensity tests, it may deduce a plurality of user propensity groups by using the data stored in another external database.

The user propensity determining unit 112 may analyze the response to the user propensity test, may gather characteristics of the respective user propensity elements, and may define the user propensity. The user propensity determining unit 112 may sum products of the responses to a plurality of questions configuring the user propensity test and sensitivity of the user propensity elements of the respective questions. The user propensity determining unit 112 may determine the user propensity based on the summing result for the respective user propensity elements. The user propensity determining unit 112 may define the characteristics of the respective users according to the importance distribution of the user propensity elements based on the response to the user propensity tests on a plurality of users.

The user propensity determining unit 112 may inquire the high-speed driving ratio and/or the low-speed driving ratio of the user of the user terminal 12. The user may input the high-speed driving ratio and/or the low-speed driving ratio to the user terminal 12. For example, the user propensity determining unit 112 may transmit a question on the highway driving ratio of the user to the user terminal 12. When the user terminal 12 receives the question, the application 121 may provide a highway driving ratio asking screen to the user through the user terminal 12. When the user inputs a response to the question through the user terminal 12, the application 121 may transmit the response to the highway driving ratio to the service providing server 11 through the user terminal 12. When receiving the response to the highway driving ratio from the user terminal 12, the user propensity determining unit 112 may determine the high-speed driving ratio and/or the low-speed driving ratio based on the received response.

When the user does not respond to the highway driving ratio, the user propensity determining unit 112 may determine the high-speed driving ratio and/or the low-speed driving ratio of the user based on the driving distance of the vehicle per unit duration of the user. The user propensity determining unit 112 may determine a city driving reference value (α) and a high-speed driving reference value (β). The city driving reference value (α) represents a driving distance of the vehicle when it is assumed that he drives in the city such as on the downtown road or the alley for a unit duration, and the high-speed driving reference value (β) represents a driving distance of the vehicle when it is assumed that he drives at high rates such as on the highway or the driveway for a unit duration. The city driving reference value (α) and the high-speed driving reference value (β) may be predetermined as initial information. For example, when the unit duration is one year, the city driving reference value (α) may be 3000 km, and the high-speed driving reference value (β) may be 50,000 km. The user propensity determining unit 112 may, as expressed in Equation 1, determine the high-speed driving ratio (x) and/or the low-speed driving ratio (y) of the user based on the city driving reference value (α), the high-speed driving reference value (β), and the driving distance of the vehicle of the user per unit duration.

$$x = \frac{γ - α}{β - α} , y = 1 - x \qquad Equation 1$$

Here, x is the high-speed driving ratio and satisfies the condition of 0≤x≤1. Also, y is the low-speed driving ratio, y is the driving distance of the vehicle of the user per unit duration, α is the city driving reference value per unit duration, and β is the high-speed driving reference value per unit duration.

For example, when the unit duration is one year, the city driving reference value (α) is 3000 km, the high-speed driving reference value (β) is 50,000 km, and the driving distance (γ) of the vehicle of the user per unit duration is 30,000 km, it is given that the user's high-speed driving ratio (x)=57.45%, and the user's low-speed driving ratio (y)=42.55%.

The user propensity determining unit 112 may transmit the data that indicate user propensities and the high-speed driving ratio and/or the low-speed driving ratio of the user to the optimal vehicle determining unit 114.

The vehicle propensity calculating unit 113 may calculate a vehicle propensity (hereinafter, a plurality of vehicle propensities) indicating vehicle characteristics for respective vehicles from authorized data, self-data, and qualitative data (S4). The vehicle propensity may be determined by a plurality of vehicle propensity elements. The vehicle propensity elements may include elements that correspond to a plurality of user propensity elements. The authorized data may include data based on Consumer Reports (CR) (US), AutoBilt (EU), MotorTrend (US), IIHS, KNCAP, EuroNCAP, Ministry of Land Infrastructure and Transport, Ministry of Environment, Ministry of Trade Industry and Energy, Korea Insurance Development Institute, JD Power (US), IF (EU), IDEA (US), and vehicle data. The self-data may be a combination of a plurality of user propensity elements and the authorized data on the vehicle providing a vehicle purchase information service based on the authorized data. The qualitative data may be values of a plurality of vehicle propensity element items for the vehicle. The vehicle propensity calculating unit 113 may transmit data indicating a plurality of vehicle propensities to the optimal vehicle determining unit 114.

The vehicle propensity calculating unit 113 may calculate a plurality of weights on the vehicle propensity elements based on data (hereinafter, vehicle data) of a plurality of vehicles and evaluation data (hereinafter, vehicle evaluation data) on the vehicles, and may determine the vehicle propensity based on the calculated weights. The vehicle data may include data, prices, colors, specifications, performance, and maintenance of the vehicle. The vehicle evaluation data may include evaluation data on the respective vehicles provided by a vehicle evaluation agency and evaluation data collected from users by the service providing server 11. The vehicle data and the vehicle evaluation data may be stored in a database of the service providing server 11. The service providing server 11 may store the vehicle data and the vehicle evaluation data, may classify the same for respective vehicles, and may store classified results in the database. The service providing server 11 may collect information on the vehicle data provided by vehicle makers, may classify them by respective vehicles, and may store resultant data in the database. The service providing server 11 may request vehicle evaluation data from a server of the evaluation agency and may collect them, may classify the collected data for respective vehicles, and may store the classified data into the database.

The vehicle propensity calculating unit 113 may calculate weights on the vehicle propensity elements based on the vehicle data and the vehicle evaluation data. The vehicle propensity elements correspond to a plurality of user propensity elements, and a plurality of vehicle propensity elements will be described to be equivalent to a plurality of user propensity elements in an embodiment. However, without being limited thereto, there may be a corresponding relationship between the vehicle propensity elements and the user propensity elements, but they may not be the same as each other.

The vehicle propensity calculating unit 113 may determine the weight on the economic feasibility that is one of the vehicle propensity elements based on the price of the vehicle and the maintenance cost for a predetermined period from among the vehicle data.

The vehicle propensity calculating unit 113 may determine the weight on the safety that is one of the vehicle propensity elements based on the authorized data from among the vehicle evaluation data and the data on safety considerations from among the vehicle data. The authorized data on safety may be collected from the Insurance Institute for Highway Safety (IIHS) (US), Korean New Car Assessment Program (KNCAP) (KOR), European New Car Assessment Programme (EuroNCAP), Ministry of Land Infrastructure and Transport, Ministry of Environment, Ministry of Trade Industry and Energy, and Korea Insurance Development Institute.

The vehicle propensity calculating unit 113 may determine the weight on the self-consciousness that is one of the vehicle propensity elements by using the vehicle evaluation data. The authorized data on the self-consciousness may be collected from Consumer Reports (CR) (US), AutoBilt (EU), and MotorTrend (US), or may be collected from survey results on brand values of the vehicle makers.

The vehicle propensity calculating unit 113 may determine the weight on the reliability that is one of the vehicle propensity elements based on the vehicle evaluation data. The authorized data on the reliability may include new vehicle quality indexes and internal quality indexes of JD Power (US).

The vehicle propensity calculating unit 113 may determine the weight on the functionality that is one of the vehicle propensity elements based on the vehicle data. The vehicle data on the functionality may include vehicle weights, performance of vehicle engines, and performance of vehicle motors.

The vehicle propensity calculating unit 113 may determine the weight on the aesthetic impression that is one of the vehicle propensity elements based on the vehicle evaluation data. The authorized data on the aesthetic impression may be collected from International Forum (IF) (EU) and International Design Excellence Award (IDEA) (US).

The vehicle propensity calculating unit 113 may determine the weight on the technical values that are one of the vehicle propensity elements based on the technology applied to the vehicle anew from among the vehicle data. For example, the weight on the technical values on the vehicle to which autonomous driving, hydrogen fueled vehicles, electric motor vehicles, and a new collision avoidance system are applied may be high.

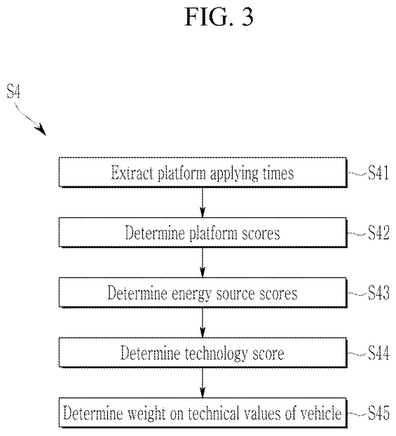

A detailed order on an operation for the vehicle propensity calculating unit 113 to determine the weight on the technical values of the vehicle in S4 will now be described with reference to FIG. 3.

FIG. 3 shows a detailed flowchart of S4 of FIG. 2.

The vehicle propensity calculating unit 113 may extract platform applying times on respective vehicles from the vehicle data (S41). The times for applying a platform to respective vehicles may be determined from a year-based model of the corresponding vehicle. For example, the platform applying time of the 2019 year-based Sonata may be the year 2019.

The vehicle propensity calculating unit 113 may determine platform scores of the respective vehicles based on the platform applying time (S42). The platform scores may be determined by the year-based model of the platform applied to the vehicle, and may be one of the indexes for determining the technical values of the vehicle. When an older platform is applied, the platform score of the vehicle may become lower. The vehicle propensity calculating unit 113 may compute the platform score of the vehicle based on a platform applying time (δ) of the vehicle, a current time (ϵ), a time (ζ) when the first platform among platforms applied to commercial vehicles is applied, and a highest score and a lowest score of the platform score. The vehicle propensity calculating unit 113 may, as expressed in Equation 2, compute a platform score difference (η) for respective years from the current time (ϵ), the time (ζ) when the first platform among platforms applied to commercial vehicles is applied, and the highest score (h) and the lowest score (i) of the platform score.

$$η = \frac{h - i}{ε - η} \qquad Equation 2$$

Here, η is the platform score differences for respective years, h is the highest score of the platform score, i is the lowest score of the platform score, ϵ is the current time (unit: year), and ζ is the time (unit: year) when the first platform among platforms applied to commercial vehicles is applied.

For example, when the current time (ϵ) is the year 2022, the time (ζ) (unit: year) when the first platform among platforms applied to commercial vehicles is applied is the year 2007, the platform score at the current time is 5 points, and the platform score at the time when the first platform among platforms applied to commercial vehicles is applied is 0 points, it is given that the platform score difference (η) for respective years=5−0/(2022−2007)=0.33 points.

The vehicle propensity calculating unit 113 may compute the platform score of the respective vehicles based on the platform score difference (η) for respective years. The vehicle propensity calculating unit 113 may compute the platform score by multiplying a number of the years from the platform applying time (δ) of the vehicle to the current time (ϵ) with the platform score difference (η) for respective years. For example, when the platform score difference (η) for respective years is 0.33, the platform score of the 2019 year-based Sonata is given as 5−(2022−2019)*0.33=4.01 points.

The vehicle propensity calculating unit 113 may determine energy source scores of the vehicles from the vehicle data (S43). The energy source scores are determined according to vehicle used fuel types and fuel systems, and may be one of the indexes for determining the technical values of the vehicles. The used fuel types may be one of diesel, gasoline, LPG, electricity, and hydrogen. The fuel systems may include a supercharger in a high-performance charger and may be one of a hybrid, a plug-in-hybrid, and a fuel cell. The energy source score may be determined based on environment-friendly vehicle-related regulations. The vehicle propensity calculating unit 113 may compute the energy source score by a summation of the scores according to the type of the vehicle used fuel and the scores according to the fuel system. For example, when the used fuel is diesel, the energy source score may be −2 points, in the case of the hydrogen vehicle, the energy source score may be +3 points, when the fuel system is hybrid, the energy source score may be +1 points, and when it is the fuel cell, the energy source score may be +2 points. Regarding the example, the vehicle propensity calculating unit 113 may determine the energy source score of the hydrogen fuel cell vehicle to be 3+2=5 points.

The vehicle propensity calculating unit 113 may determine the technology score by a summation of the platform scores of the respective vehicles and the energy source scores (S44). The vehicle propensity calculating unit 113 may determine the weight on the technical values of the vehicle based on the technology score (S45).

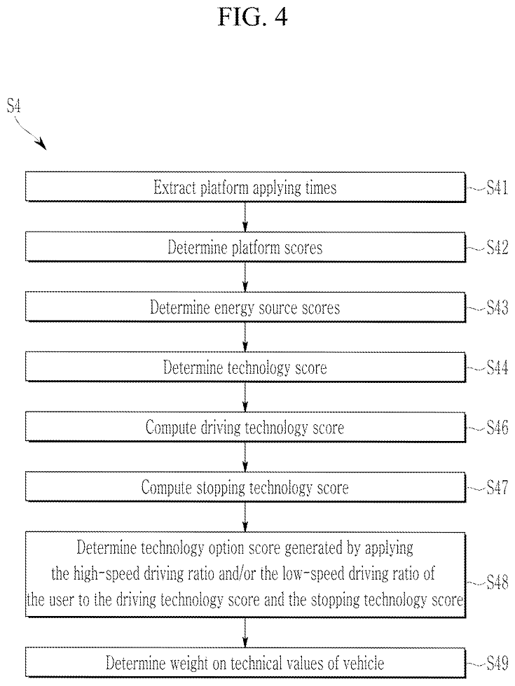

As described above, the vehicle propensity calculating unit 113 may determine the technology score according to the platform applied to the vehicle and the energy source, and may determine the weight on the technical values of the vehicle based on the technology score. The vehicle propensity calculating unit 113 may also determine the technology option score by considering the high-speed driving ratio and/or the low-speed driving ratio of the user and the option specification applied to the vehicle, and may determine the weight on the technical values of the vehicle based on the technology score and the technology option score. A detailed order of an operation for the vehicle propensity calculating unit 113 to determine the technology option score by considering the high-speed driving ratio and/or the low-speed driving ratio of the user and the option specification applied to the vehicle and determine the weight on the technical values of the vehicle based on the technology score and the technology option score in S4 will now be described with reference to FIG. 4.

FIG. 4 shows a detailed flowchart of S4 of FIG. 2.

Descriptions of S41 to S44 of FIG. 4 correspond to the descriptions of S41 to S44 of FIG. 3.

The vehicle propensity calculating unit 113 may compute the driving technology score (S46). The driving technology score is applied to the option specification (hereinafter, driving option specification) on a function for supporting a driver of the vehicle while the vehicle runs on the road, and may be an index for indicating convenience of the vehicle driving at a high speed.

From among a plurality of option specifications of the vehicle, an item that corresponds to the driving option specification may be classified as initial information. The vehicle propensity calculating unit 113 may determine the driving technology score by summing the technology scores of the respective driving option specification items of the vehicle. Here, the technology scores of the respective driving option specification items may be predetermined to be initial information. For example, from among a plurality of option specifications applied to one vehicle, navigation, autonomous driving, and intelligent headlamps are the driving option specifications, and when the technology score of the navigation is 1 point, the autonomous driving is 2 points, and the technology score of the intelligent headlamp is 1 point, the vehicle propensity calculating unit 113 may determine the driving technology score of one vehicle to be 1+2+1=4 points. The vehicle propensity calculating unit 113 may compute the driving technology score (A) by a summation of the technology scores of the respective items that correspond to the driving option specification from among a plurality of option specifications applied to the vehicles.

The vehicle propensity calculating unit 113 may compute the stopping technology score (S47). The stopping technology score is applied to an option specification (hereinafter, stopping option specification) on a function for supporting the driver of the vehicle during stopping and/or parking the vehicle and before/after stopping and/or parking it, and may be an index for indicating convenience when he drives the vehicle in the city.

From among a plurality of option specifications of the vehicle, the item that corresponds to the stopping option specification may be distinguished as initial information. The vehicle propensity calculating unit 113 may determine the stopping technology score by summing the technology score of the respective stopping option specification items of the vehicle. The technology scores of the respective stopping option specification items may be predetermined as initial information. For example, when button starting, an auxiliary parking device, and car pay (that is a service to pay on a navigation screen at an affiliated franchise without using an actual credit card) are stopping option specifications from among a plurality of option specifications applied to one vehicle, the technology score of the button starting is 1 point, the technology score of the auxiliary parking device is 1 point, and the technology score of the car pay is 1 point, the vehicle propensity calculating unit 113 may determine the stopping technology score of one vehicle to be 1+1+1=3 points. The vehicle propensity calculating unit 113 may compute the stopping technology score (B) by a summation of the technology scores of the respective items that correspond to the stopping option specification from among a plurality of option specifications applied to the respective vehicles.

The vehicle propensity calculating unit 113 may determine the technology option score (Γ) generated by applying the high-speed driving ratio (x) and/or the low-speed driving ratio (y) of the user to the driving technology score (A) and the stopping technology score (B) (S48). The vehicle propensity calculating unit 113 may determine the technology option score (Γ) based on the driving technology score (A), the stopping technology score (B), and the high-speed driving ratio (x) and/or the low-speed driving ratio (y) of the user, as expressed in Equation 3.

Γ=A*x+B*y Equation 3

For example, when the driving technology score (A) is 4 points, the stopping technology score (B) is 3 points, the high-speed driving ratio (x) is 57.45%, and the low-speed driving ratio (y) is 42.55%, the technology option score (τ) is 4*0.5745+3*0.4255=3.57 points.

The vehicle propensity calculating unit 113 may determine the weight on the technical values of the vehicle based on the technology score determined in S44 and the technology option score determined in S48 (S49).

The vehicle propensity calculating unit 113 may determine the weight on the technical values that is one of the vehicle propensity elements according to S45 of FIG. 3 or S49 of FIG. 4.

The above-provided description is an embodiment, and is not limited thereto. The vehicle propensity calculating unit 113 may use at least one of the vehicle data and the vehicle evaluation data when determining the vehicle propensity element, which is not limited thereto. For example, the vehicle propensity calculating unit 113 may determine the weight on the vehicle propensity element by using the data stored by the vehicle recommending system 1 together with or instead of the authorized data.

The service providing server 11 may generate data for indicating a plurality of vehicle propensities for respective vehicles. The service providing server 11 may store data for indicating a plurality of vehicle propensities for respective vehicles in the database. The service providing server 11 may perform the step of S5 based on the data for indicating stored vehicle propensities instead of S4.

The optimal vehicle determining unit 114 may determine a plurality of target vehicles according to a vehicle purchase budget range of the user from among a plurality of vehicles, and may determine the optimal vehicle from among the target vehicles based on the user propensity and a plurality of vehicle propensities (S5). The optimal vehicle determining unit 114 may determine a plurality of target vehicles from among a plurality of vehicles. The optimal vehicle determining unit 114 may consider the vehicle purchase budget range of the user when determining a plurality of target vehicles. The optimal vehicle determining unit 114 may compute matching degrees of a plurality of target vehicles according to a comparison result of vehicle propensities of the target vehicles and the user propensities. The optimal vehicle determining unit 114 may sequentially set a matching order from the greatest matching degree to the smallest one. The optimal vehicle determining unit 114 may determine the optimal vehicle from a plurality of target vehicles according to a matching order of a plurality of target vehicles.

The optimal vehicle determining unit 114 may compute the matching degrees of respective target vehicles by using at least one of a standard deviation method, a factoring method, and a hybrid method based on the data indicating the user propensity and the vehicle propensity. The optimal vehicle determining unit 114 may use at least one of the standard deviation method, the factoring method, and the hybrid method for quantizing the matching degree between the vehicle propensity and the user propensity.

For example, when the optimal vehicle determining unit 114 uses the standard deviation method, differences between weights of the respective user propensity elements and weights of the respective vehicle propensity elements may be calculated. The optimal vehicle determining unit 114 may compute the matching degree according to the result of summing the differences calculated through the standard deviation method on a plurality of user propensity elements and a plurality of vehicle propensity elements for the respective target vehicles. Here, the optimal vehicle determining unit 114 may determine the matching degree to be greater as the summation results of the differences calculated by the standard deviation method become smaller.

In another way, when the optimal vehicle determining unit 114 uses the factoring method, the product of the weights of the respective user propensity elements and the weights of the respective vehicle propensity elements may be calculated. The optimal vehicle determining unit 114 may compute the matching degree according to the result of summing the products of a plurality of user propensity elements and a plurality of vehicle propensity elements by the factoring method for a plurality of target vehicles. Here, the optimal vehicle determining unit 114 may determine the matching degree to be greater as the result of summing the products calculated by the factoring method becomes greater.

In another way, when the optimal vehicle determining unit 114 uses the hybrid method, it may deduce candidate vehicles from a plurality of target vehicles according to the factoring method, and may apply the standard deviation method to the candidate vehicles to determine the matching order. For example, the optimal vehicle determining unit 114 may deduce a predetermined number of top vehicles as candidate vehicles from among the total sum of a plurality of vehicle propensity elements for respective vehicles deduced by the factoring method. The optimal vehicle determining unit 114 may set the matching order on the candidate vehicles from the least standard deviation to the greatest one according to the standard deviation method.

As described, the optimal vehicle determining unit 114 may differently determine the matching order according to the standard deviation method, the factoring method, and a hybrid method. The optimal vehicle determining unit 114 may determine one of the standard deviation method, the factoring method, and the hybrid method based on user input from the user terminal 12. In addition, the method for determining the matching order by using the standard deviation method, the factoring method, and the hybrid method is not limited thereto.

The optimal vehicle determining unit 114 may determine at least one vehicle of which the matching order belongs to a predetermined range to be the optimal vehicle from among a plurality of target vehicles. For example, the optimal vehicle determining unit 114 may determine three vehicles of which the matching order corresponds to the top three to be the optimal vehicles from among a plurality of target vehicles.

Referring to FIG. 2, the service providing server 11 may provide a vehicle purchase information service on the optimal vehicle to the user through the user terminal 12 (S6). The service providing server 11 may transmit data for indicating the optimal vehicle to the user terminal 12. The data for indicating the optimal vehicle may include a vehicle type, a powertrain, a trim, and an option specification for indicating the optimal vehicle. When the user terminal 12 receives the data for indicating an optimal vehicle, the application 121 may provide an optimal vehicle displaying screen to the user through the user terminal 12.

While embodiments of this invention have been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method for recommending a vehicle performed by a service providing server, the method comprising:
providing a question for a user and a user propensity test to an application through a user terminal;
receiving responses to the question for the user and the user propensity test from the user terminal and determining a user propensity based on the responses;
calculating a plurality of vehicle propensities for indicating vehicle characteristics on a plurality of vehicles, wherein calculating the plurality of vehicle propensities comprises extracting a platform applying time of each of the vehicles and a used fuel type from vehicle data and determining a weight on one of a plurality of vehicle propensity elements on the vehicle by summing platform scores according to the platform applying time and energy source scores according to the used fuel type;
determining a plurality of target vehicles belonging to a vehicle purchase budget range of the user from among the plurality of vehicles; and
determining at least one optimal vehicle from among the target vehicles based on matching degrees of the user propensity and the respective target vehicles.

2. The method of claim 1, wherein determining the weight on the one of the plurality of vehicle propensity elements comprises determining the energy source score by summing a score according to the used fuel type of the vehicle and a score according to a type of a fuel system of the vehicle.

3. The method of claim 1, wherein determining the weight on the one of the plurality of vehicle propensity elements comprises:
computing platform score differences for respective years by dividing a difference between a highest score of a platform score and a lowest score of the platform score by a difference between a current year and a year in which a first platform among platforms applied to commercial vehicles is applied; and
determining the platform score by multiplying a number of years from the platform applying time of the vehicle to the current year with the platform score difference for respective years.

4. The method of claim 3, wherein determining the user propensity comprises, in response to receiving a response to a high-speed driving ratio query of the user from the user terminal, determining the high-speed driving ratio of the user according to the response.

5. The method of claim 4, wherein determining the user propensity comprises, in response to not receiving the response to the high-speed driving ratio query, determining the high-speed driving ratio of the user by dividing a subtraction of a reference value of a city driving per unit duration of the user from a driving distance of the vehicle per unit duration by a difference between a high-speed driving reference value per unit duration and the reference value of city driving.

6. The method of claim 5, wherein calculating the plurality of vehicle propensities further comprises:
determining a driving technology score by summing scores of respective driving option specifications on a function for supporting a driver while driving the vehicle from among a plurality of option specifications applied to the vehicle;
determining a stopping technology score by summing scores of respective stopping option specifications on stopping or parking from among the option specifications;
determining a technology option score by adding a product of the driving technology score and the high-speed driving ratio and a product of the stopping technology score and a low-speed driving ratio according to the high-speed driving ratio; and
determining the weight on the one of the plurality of vehicle propensity elements on the vehicle based on the platform score, the energy source score, and the technology option score.

7. A service providing server comprising:
a processor;
a memory connected to the processor and configured to store program codes;
a collecting unit configured to collect user information and a response to a user propensity test from a user terminal, wherein the user information comprises a response to a question for a user;
a user propensity determining unit configured to determine a user propensity based on the user information and the response to the user propensity test;
a vehicle propensity calculating unit configured to:
calculate a plurality of vehicle propensities indicating characteristics of a plurality of vehicles;
extract a platform applying time of each vehicle of the plurality of vehicles and a type of a used fuel from vehicle data; and
sum a platform score according to the platform applying time and an energy source score according to the type of the used fuel to determine a weight on one of a plurality of vehicle propensity elements indicating the vehicle propensity of the plurality of vehicle propensities; and
an optimal vehicle determining unit configured to:
determine a plurality of target vehicles belonging to a vehicle purchase budget range of the user from among the vehicles; and
determine an optimal vehicle from among the target vehicles according to a matching degree by which the respective target vehicles match the user propensity.

8. The service providing server of claim 7, wherein the vehicle propensity calculating unit is configured to:
compute platform score differences for respective years by dividing a difference between a highest score of the platform score and a lowest score of the platform score by a difference between a current year and a year in which a first platform among platforms applied to commercial vehicles is applied; and
determine the platform score of the vehicle by multiplying a number of years from the platform applying time of the vehicle to the current year with the platform score difference for respective years.

9. The service providing server of claim 7, wherein the vehicle propensity calculating unit is configured to determine the energy source score by a summation of a score according to the type of the used fuel of the vehicle and a score according to a type of a fuel system of the vehicle.

10. The service providing server of claim 7, wherein the user propensity determining unit is configured to:
inquire the user terminal of a high-speed driving ratio of the user;
in response to receiving a response, determine the high-speed driving ratio of the user according to the response; and
in response to not receiving the response, determine the high-speed driving ratio of the user by dividing a subtraction of a reference value of a city driving per unit duration of the user from a driving distance of the vehicle per the unit duration by a difference between a high-speed driving reference value per unit duration and the reference value of city driving.

11. The service providing server of claim 10, wherein the vehicle propensity calculating unit is configured to:
determine a technology option score by adding a product of a driving technology score that is a summation of scores of respective driving option specifications on a function for supporting a driver while driving the vehicle from among a plurality of option specifications applied to the vehicle and the high-speed driving ratio and a product of a stopping technology score that is a summation of scores of respective stopping option specifications on stopping or parking from among the option specifications and a low-speed driving ratio according to the high-speed driving ratio; and
determine the weight on the one of the plurality of vehicle propensity elements on the vehicle based on the platform score, the energy source score, and the technology option score.

12. A system for recommending a vehicle, the system comprising:
a user terminal comprising an application; and
a service providing server connected to the user terminal by a network, the service providing server comprising:
a collecting unit configured to collect user information and a response to a user propensity test from the user terminal, wherein the user information comprises a response to a question for a user;
a user propensity determining unit configured to determine a user propensity based on the user information and the response to the user propensity test;
a vehicle propensity calculating unit configured to:
calculate a plurality of vehicle propensities indicating characteristics of a plurality of vehicles;
extract a platform applying time of each vehicle of the plurality of vehicles and a type of a used fuel from vehicle data; and
sum a platform score according to the platform applying time and an energy source score according to the type of the used fuel to determine a weight on one of a plurality of vehicle propensity elements indicating the vehicle propensity of the plurality of vehicle propensities; and
an optimal vehicle determining unit configured to:
determine a plurality of target vehicles belonging to a vehicle purchase budget range of the user from among the vehicles; and
determine an optimal vehicle from among the target vehicles according to a matching degree by which the respective target vehicles match the user propensity.

13. The system of claim 12, wherein the vehicle propensity calculating unit is configured to:
compute platform score differences for respective years by dividing a difference between a highest score of the platform score and a lowest score of the platform score by a difference between a current year and a year in which a first platform among platforms applied to commercial vehicles is applied; and
determine the platform score of the vehicle by multiplying a number of years from the platform applying time of the vehicle to the current year with the platform score difference for respective years.

14. The system of claim 12, wherein the vehicle propensity calculating unit is configured to determine the energy source score by a summation of a score according to the type of the used fuel of the vehicle and a score according to a type of a fuel system of the vehicle.

15. The system of claim 12, wherein the user propensity determining unit is configured to:
send an inquiry of a high-speed driving ratio of the user to the user terminal;
in response to receiving a response, determine the high-speed driving ratio of the user according to the response; and
in response to not receiving the response, determine the high-speed driving ratio of the user by dividing a subtraction of a reference value of a city driving per unit duration of the user from a driving distance of the vehicle per the unit duration by a difference between a high-speed driving reference value per unit duration and the reference value of city driving.

16. The system of claim 15, wherein the vehicle propensity calculating unit is configured to:
determine a technology option score by adding a product of a driving technology score that is a summation of scores of respective driving option specifications on a function for supporting a driver while driving the vehicle from among a plurality of option specifications applied to the vehicle and the high-speed driving ratio and a product of a stopping technology score that is a summation of scores of respective stopping option specifications on stopping or parking from among the option specifications and a low-speed driving ratio according to the high-speed driving ratio; and
determine the weight on the one of the plurality of vehicle propensity elements on the vehicle based on the platform score, the energy source score, and the technology option score.
